(19) United States
(12) Patent Application Publication
(10) Pub. No.: US 2009/0006161 A1
(43) Pub. Date: Jan. 1, 2009

(54) SYSTEMS AND METHODS FOR MANAGING EVENTS OF EVENT SCHEDULING APPLICATIONS

(76) Inventors: Yen-Fu Chen, Austin, TX (US); Fabian F. Morgan, Austin, TX (US); Keith R. Walker, Austin, TX (US); Sarah V. White Eagle, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 11/769,605

(22) Filed: Jun. 27, 2007

(51) Int. Cl. G06Q 10/00; G06F 17/40

(52) U.S. Cl. 705/8

(57) ABSTRACT

Systems, methods, and computer program products for managing events in time management or event scheduling applications, such as calendar applications, are disclosed. Embodiments comprise analyzing event parameters, such as selections from input solicited from prospective meeting attendees that are associated with events of the meeting, determining an arrangement of the events based on the analysis of the event parameters, and proposing the arrangement. System embodiments generally comprise a list of events for the meeting, such as event items in a database, a constraint solver to analyze parameters of events of the list, and an arrangement module to select an arrangement of the events based on analysis by the constraint solver.

### FIELD

The present invention generally relates to the fields of time management, appointment scheduling, event scheduling, meeting management, and calendaring applications. More particularly, the present invention relates to systems, methods, and computer program products for managing events in time management or event scheduling applications, such as calendar applications.

### BACKGROUND

Time management and event scheduling applications have become integral parts of the lives of many people. People use calendar applications to help them manage business schedules and daily activities, such as for making appointments for various types of meetings. Electronic calendar applications, such as Lotus Notes®, Microsoft Outlook®, Mozilla® Sunbird™, and other types of calendaring and e-mail suites or programs provide capabilities for scheduling meetings.

People, such as managers and team leaders, use calendar applications or time management applications to schedule meetings with their respective employees or team members. A person may use the calendar application to schedule a meeting time and send invitations for the meeting to prospective attendees. Generally, each attendee invited to the meeting may accept, decline, or ignore the invitation. The calendar applications may notify the person scheduling the meeting which attendees have accepted, declined, and ignored the invitations. The calendar applications may update or make appropriate entries, or reservations, in the calendars of the attendees or invitees which have accepted the invitations to attend the meeting.

One big drawback of existing calendar applications is they do not allow a user to work with events within meetings, which may be thought of as “sub-meetings.” The existing calendar and time management applications do not allow for automatic coordination and scheduling of meetings that consist of multiple events having multiple time slots. Additionally, meeting coordinators often need to conduct meetings that require the attendances of specific individuals. To ensure the attendances of those specific individuals, the meeting coordinators may be forced to send out requests for available times for the meetings and select times that are available to all. Finding such suitable times for the meetings often consumes precious time that could be better spent on other more productive activities.

Given the current art, therefore, alternative methods, systems, and computer program products are needed to manage events in time management applications, such as calendar applications. Such alternative methods, systems, and programs may help meeting coordinators define meetings, may allow the coordinators to specify events for those meetings, and may help select arrangements for the events based on parameters specified by prospective attendees.

### BRIEF DESCRIPTION OF THE DRAWINGS

Aspects of the embodiments will become apparent upon reading the following detailed description and upon reference to the accompanying drawings in which like references may indicate similar elements:

FIG. 1 depicts a system for managing events in a calendar application based on parameters for the events;

FIG. 2 depicts an embodiment of a screen that a meeting coordinator may use to create meetings, including the creation of events for the meetings;

FIG. 3 shows an alternative embodiment of an interface screen that a meeting coordinator may use to create meetings, including the creation of events for the meetings;

FIG. 4 shows an embodiment of an interface screen that a meeting coordinator may use to select among various proposed meeting scenarios;

FIG. 5 shows an embodiment of an interface screen that a prospective meeting attendee may use to input preferences for various available time slots for a meeting being scheduled;

FIG. 6 shows an apparatus for arranging events of a meeting, comprising a meeting input module, an event list, a constraint solver, an arrangement module, and an invitation module;

FIGS. 7A-C depict a flowchart of an algorithm for managing events of a calendar application based on parameters for the events; and

FIG. 8 illustrates a method embodiment for arranging events of a meeting based on specified event parameters of prospective attendees for the meeting.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, the present invention relates to systems, methods, and computer program products for managing events in time management or event scheduling applications, such as calendar applications. Method embodiments generally comprise defining events of a meeting, analyzing event parameters, such as selections solicited from prospective meeting attendees that are associated with events of the meeting, and determining an arrangement of the events based on the analysis of the event parameters. Some method embodiments also propose the arrangement. Some method embodiments involve sending invitations for the meeting to prospective attendees.

Various method embodiments may propose an alternate arrangement based on a modification by a prospective attendee, a meeting coordinator, or both. Some embodiments determine an arrangement of the events based on the analysis of the event parameters by analyzing multiple available time slots for the events received from a plurality of the prospective attendees. Various embodiments propose the arrangement by scheduling the events in electronic calendars of the prospective attendees.

System embodiments may also arrange events of a meeting. The system embodiments generally comprise a list of events for the meeting, such as event items in a database, a constraint solver to analyze parameters of events of the list, and an arrangement module to select an arrangement of the events based on analysis by the constraint solver. Alternative system embodiments may include a meeting input module to receive details of the events. Some embodiments may have an invitation module to send invitations to prospective attendees.

In some system embodiments, the invitation module may solicit input for the parameters from prospective attendees. Such input may be available time slots for attendees or priorities of available time slots for attendees. In some system embodiments, the invitation module may communicate the selected arrangement to attendees for a specific event in order to solicit input for the specific event. For some of these system embodiments, the arrangement module may select an alternative arrangement based on the solicited input.

As for the types of information that the constraint solver may analyze, it may evaluate or consider available time slots of one or more people, such as people attending the meeting, priorities of available time slots for attendees, and multiple available time slots for the events received from multiple attendees. In some system embodiments, the arrangement module may select the arrangement based on participation by an attendee in two consecutive events. Some method embodiments may also have the arrangement module automatically select an alternative arrangement of the events based on a modification by a meeting chair or an attendee.

Many of the discussions of the various embodiments have the term “arrange”. Worth emphasizing is the fact that “arranging” events of a meeting may, in some instances, involve selecting the order of the events. For example, an embodiment may determine that a first event is to take place before a second event, which comes before a third event, etc., based on availability and preferences of attendees. However, the terms “arrange” or “arranging” may also generally include such activities as planning, organizing, and specifying which attendees may participate in certain events. In other words, the term “arrange” should not be limited to or interpreted as only determining an order of events. “Arrange” may include the general acts of planning, organizing, and specifying details or parameters associated with the events, such as which attendees will participate or otherwise be associated with certain events.

Many of the discussions also use the terms “meeting coordinator” and “prospective attendee”. The term “meeting coordinator” may, depending on the embodiment or the situation, mean a supervisor of a group of people. However, the term may also be interpreted to mean one of the participants to the meeting, who is a coworker of other people who will be attending the event. Additionally, the meeting coordinator may not be a person participating in the meeting at all. For example, a supervisor may ask his or her secretary to schedule a meeting, wherein the secretary may not attend the meeting. “Prospective attendee” may generally be thought of as a person who is expected to attend the meeting, in other words an attendee. However, the person may not be able to attend, for one reason or another, and may have an alternate person attend the meeting in his or her place. Additionally, worth emphasizing, is the fact that “meeting coordinator” and “prospective attendee” may refer to people who do not actually attend the meeting.

Some of the discussions use the terms “server” and “client”. Generally, the term “server” may refer to a computer or device on a network that manages network resources. Clients may generally be thought of as computer applications running on computer systems that access the services provided by server applications and dedicated server computers. However, in several instances in the discussion these terms are interchangeable. Accordingly, one should not conclude that a discussion that uses only “client” or “server” terms, as opposed to using “computer” or “computer systems” terms, is meant to limit the discussion to one term or the other. One of ordinary skill in the art will recognize that such variations may be substituted for the described methods and systems, and employed in accordance with similar constraints, to perform substantially equivalent functions.

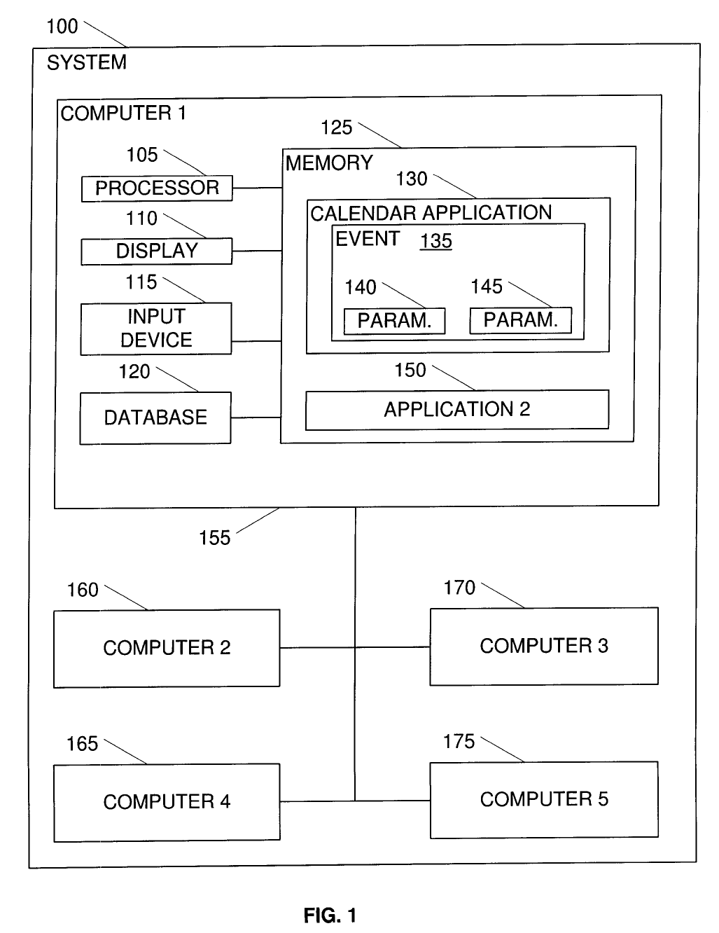

Turning to the drawings, FIG. 1 illustrates a system 100 which may comprise several different computers for managing events in a calendar application 130 based on parameters for the events. For example, system 100 may allow a meeting coordinator to schedule, prioritize, and arrange events, such as agenda items, for a meeting based upon parameters associated with the events. System 100 may comprise a network having many interconnected computing devices. For example computer 155 may comprise a desktop or laptop computer connected to a number of other computers, such as computers 160, 165, 170, and 175.

The computers of system 100 may comprise different types of computing devices. For example, each computer may comprise a desktop or a laptop computer. In alternative embodiments, one or more of the computers in system 100 may comprise portable computing devices, such as wireless personal digital assistants (PDAs) or palm-held personal computing devices. Additionally, the computers of system 100 may comprise a mixture of server and client computing devices. For example, computer 155 may comprise a server running calendar application 130 that users of client computers, such as computers 165 and 170, may access.

The computers of system 100 may connect to other computers of system 100 using a variety of different hardware in various embodiments. For example, computer 160 may comprise a desktop computer connected to computer 155 via an Ethernet cable coupled to a local or wide area network (LAN or WAN). Computer 175 may comprise a combination cellular telephone/PDA device coupled to computer 155 via a wireless virtual private network (VPN) link and located across town or in another country. In other words, various embodiments of system 100 may comprise an almost limitless number of wired and wireless communication devices, allowing computers of system 100 to communicate with each other, wherein the computers may be located close to or remote from each other.

The computers of system 100 may each execute a variety of different applications and communicate with each other in a variety of different ways. For example, in addition to calendar application 130 computer 155 may run a second application 150, which may be an e-mail server application. That is to say, application 150 may comprise a simple mail transfer protocol (SMTP) server application. Calendar application 130 may work in conjunction with the SMTP application, sending e-mails to and/or receiving e-mails from users of system 100. Alternatively, application 150 may comprise a web page server, a file transfer protocol (FTP) server, a gopher server, or a telnet server, as examples. In other words, applications 130 and 150 may establish communication links or sessions with applications running on computers 160, 165, 170, and 175. Applications on computers 160, 165, 170, and 175 may also be SMTP server applications, telnet servers or clients, local calendaring applications, time management applications, dedicated e-mail applications, web browsers, and so on.

System 100 may have a processor 105 for executing program instructions for different types of applications, such as calendar application 130 and application 150, that may be in memory 125. Using calendar application 130, system 100 may implement a technique for managing business schedules and daily activities for a person or a group of people. Stated differently, system 100 may allow automatic coordination and scheduling of meetings and other types of activities, wherein the meetings and activities have multiple time slots as “sub-meetings” or “events” of the activities. Additionally, calendar application 130 may allow such automatic coordination and scheduling by interacting with other calendar applications running on the computers of other users of system 100, such as users of computers 160, 165, 170, and 175. For example, calendar application 130 may comprise Lotus Notes®, interacting with Microsoft Outlook® on computer 160, Mozilla® Sunbird™ on computer 165, Daytimer® on computer 170, and Palm Organizer® on computer 175. Calendar application 130 may arrange events of a calendar activity based on parameters of the events, such as availability of attendees for the events, prioritized feedback from the attendees, etc.

System 100 may display data of calendar application 130 on a display 110. Display 110 may allow the user to view activities, events, and parameters related to those events for calendar application 130. Display 110 may also show input from other users for events to be scheduled by calendar application 130 and allow the user of computer 155 to edit the activities, arrangement, and priorities of events for calendar application 130. The user of computer 155, which may be a meeting coordinator, may edit activities and events of calendar application 130 using input device 115. For example, input device 115 may comprise a keyboard and/or a mouse. In some embodiments input device 115 may comprise a tablet and stylus, such as a pressure-sensitive surface in a PDA that recognizes hand-written characters. In even further embodiments input device 115 may comprise an audible input device, such as a microphone used for speech recognition.

System 100 may automatically schedule activities based on parameters related to events of the activities. As depicted in FIG. 1, calendar application 130 may have an event 135 having parameter 140 and parameter 145. Event 130 may represent an item for a meeting, such as a speech or a presentation. While not depicted in FIG. 1, calendar application 130 may have many more events than event 135. For example, calendar application 130 may have twenty appointments scheduled for a particular week. Appointments may be things such as meetings, telephone conferences, and performance reviews, just to name a few. Some of the appointments may have numerous events or sub-meetings associated with them. System 100 may divide the appointments into discrete events and use parameters associated with the events, such as parameters 140 and 145 as well as input from people associated with the events, to prioritize and/or arrange the events. In other words, system 100 may place events for a meeting in a particular order or more generally plan or organize the events, based on parameters of the events which may include input from users involved with the events. A specific example will help illustrate this concept.

A user of computer 170 may be scheduled to give a presentation. User of computer 170 may receive a meeting invitation from the user of computer 155, which may be the meeting coordinator or meeting chair. If the automatic scheduling feature of system 100 is turned off, or disabled, the meeting coordinator may send the invitation with a duration of two hours, from 9:00 AM-11:00 AM. However, the user of computer 170 may be responsible for a small portion of the presentation that only requires forty minutes during the first hour. With the automatic scheduling feature of system 100 disabled, which could otherwise allow more flexibility for “sub-meetings”, the user of computer 170 may have no choice but to accept the invitation for the entire two hours.

Suppose that the user of computer 165 only has one hour available on the same day, from 10:00-11:00 AM, and needs to meet with the user of computer 170. The user of computer 165 may attempt to reserve one hour on the calendar of user of computer 170. Unfortunately, since the user of computer 170 accepted the meeting invitation from the user of computer 155, the user of computer 165 will gain the misimpression that the user of computer 170 is unavailable from 10:00-11:00 AM, even though the user of computer 170 may leave the meeting after giving the presentation and actually be available from 10:00-11:00 AM. The user of computer 165 would be required to contact the user of computer 170 to find out whether the user could alter his or her schedule in order to meet. This problem would not occur if the user of computer 155 enabled the sub-meeting or event feature of system 100, which would allow the user of computer 170 to only accept the portion of the two hour meeting lasting from 9:00-10:00 AM. Stated more succinctly, system 100 may enable the user of computer 155 to schedule the two hour meeting, have the user of computer 170 attend only the first hour, and enable the user of computer 165 to schedule an appointment on the calendar application of user of computer 170, which would otherwise be shown as unavailable.

In another scenario, one or more prospective attendees of the meeting may accept just a segment of time occupied by a meeting. For example, if a meeting lasts from 2:00 p.m. to 4:00 p.m., system 100 may allow a prospective attendee to accept only the portion of the meeting that is from 2:30 p.m. to 3:00 p.m., and reserve this time in a calendar of the prospective attendee.

The time segment accepted by the prospective attendee may be selected in a variety of ways in various embodiments. In one embodiment the prospective attendee may select from a predetermined number and range of slots. For example, the meeting coordinator may choose to divide the meeting into four equal slots of half an hour. The prospective attendee may make an ad-hoc determination of the time period he or she will attend. For example, a prospective attendee or user may specify that she will attend from 2:15 p.m. to 2:50 p.m., and may indicate this preference, or parameter, by clicking and dragging a mouse in a user interface until the desired time segment has been selected.

Depending on the embodiment, the time slots that prospective attendees have chosen may be updated in real-time. For example, if the user of computer 175 receives an invitation, opens it, and then goes to lunch, when the user of the computer 175 returns and someone else has already chosen a slot, then system 100 may gray out that slot or otherwise disable the slot on the calendar of the screen of computer 175. In some embodiments, the user of the computer 175 may hover the pointer of the mouse over the grayed out slot to see who took the slot and may invoke a command to that person to see if they can switch time slots. For example, the command may trigger an instant message, an e-mail, a telephone call, an automated telephone message asking for a switch, etc.

Alternatively, the time slots may not be exclusive. In other words, many attendees may have the ability to attend the same slot. An example where this scenario may be appropriate is a meeting that gives an overview of a several newly released products of a company. An attendee may only wish to attend the portion of the presentation that relates to the product he or she has worked on and sign up for only that slot, or the attendee may wish to stay and view other products of coworkers and sign up for those slots as well.

In yet another version, similar to the scenarios just described, the user of computer 170 may be scheduled to give the forty minute presentation during the scheduled two hour meeting of the user of computer 155. The presentation may be event 135 in calendar application 130. The user of computer 170 may accept the invitation for the first portion, or hour, of the meeting. However, in reality, the user of computer 170 and the user of computer 155 may not care whether the presentation occurs during the first half or the second half of the meeting. Additionally, the user of computer 160 may need to meet with the user of computer 170 and only be able to meet during the hour that has already been reserved for the presentation. System 100 may allow the user of computer 160 to see that the user of computer 170 may give the presentation in either the first hour of the meeting or the second hour. The user of computer 160 may request that the user of computer 170 place a lower priority on the period of the first hour, or even indicate that the user of computer 170 is unavailable to meet during the first hour due to the conflict. The user of computer 170 may indicate this preference using an event parameter, such as parameter 140. During the scheduling process, system 100 may evaluate parameter 140 for event 135 and schedule the presentation, event 135, during the second hour of the meeting. Such evaluation during scheduling the event will allow the user of computer 170 to both meet with the user the computer 160 and give the presentation during the second hour of the meeting.

Alternatively, system 100 may allow the users of computers 170 and 160 to move the presentation from the first hour to the second hour after system 100 has already evaluated, arranged, and presented the proposed arrangement of events. System 100 may allow the users of computers 170 and 160 to make this change without necessarily involving too many other users of system 100. System 100 may simply look at the parameters of the other events for the meeting, determine whether the other events have parameters requiring them to occur at a specific time or whether they can be moved, and rearrange the order of events to accommodate the requested change by the users of computers 170 and 160. Assuming the events can be reordered, system 100 may update the schedules of the affected users, or meeting attendees, in calendar application 130 and/or calendar applications running on computers 160, 165, 170, and 175.

The calendar applications of system 100, as well as the other applications of the computers in system 100, may communicate with each other using a variety of communication protocols. For example, applications 130 and 150 may use simple mail transfer protocol, FTP, or Hyper Text Transfer Protocol (HTTP). Additionally, depending on the embodiment, the computers of system 100 may run various types of operating systems. For example, computers 155, 160, 165, 170, and 175 may run Unix®, Microsoft® Windows®, OS/2®, Linux®, DOS, or Mac OS®. Each computer may run the same operating system as the others or a different one.

Appointments and related events of calendar application 130 may be stored in a database 120. For example, database 120 may comprise a calendar database for calendar application 130, storing lists of appointments, lists of events, and lists of parameters for the events. System 100 may store database 120 in a mass storage device. For example database 120 may reside on a parallel or serial hard disk drive. Database 120 may also be stored on an optical storage device, such as a rewritable compact disc (CD) or a digital versatile disc (DVD) drive. In other embodiments, database 120 may reside in a flash memory device, such as a universal serial bus (USB) thumb drive.

While the preceding example discussed a system 100 employing local memory 125 and a local database 120, alternative embodiments may comprise a system 100 executing or accessing programs and documents in remote locations. For example, application 130 may actually comprise two programs, one on a local client system and another on a remote server system. The local client program may be a web browser running a Java application for a web page of a calendar or time management application. The time management web page may have been downloaded from a remote server system. The user of computer 155 may use application 130 to insert parameters 140 and 145, review and approve schedules arranged by system 100, and modify activity events and event parameters. As a person skilled in the art will quickly appreciate, system 100 may comprise numerous communication and networking configurations, with almost unlimited combinations of local and remote event scheduling applications.

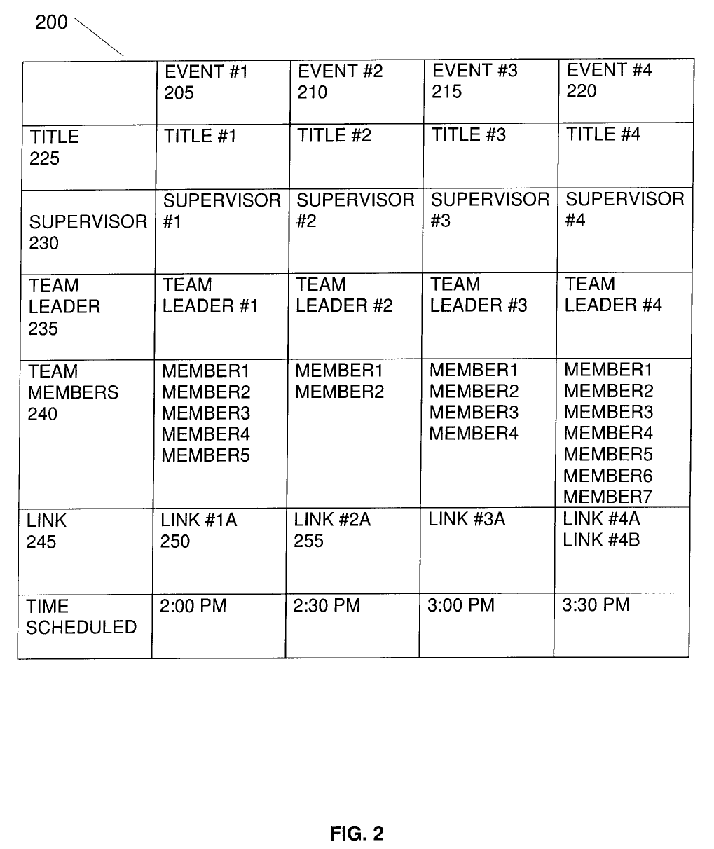

FIG. 2 depicts one embodiment of a screen 200 that a meeting coordinator may use to create meetings, including the creation of events for the meetings. Assume, for the purpose of an example, that the meeting coordinator has a weekly two hour meeting from 2:00-4:00 P.M. that consists of four time slots, thirty (30) minutes each, where a topic or event is discussed or covered during that time slot. In other words, four different topics may be addressed in the meeting, each within its own time slot of thirty minutes.

Screen 200 illustrates four events (events 205, 210, 215, and 220) in columnar format. The meeting coordinator may use a title field 225 to assign a title to each of the events. Additionally, the meeting coordinator may be able to enter details for individual supervisors responsible for each of the events using supervisor field 230, details for the team leader responsible for each event using team leader field 235, and members of the team that participate or contribute to the individual events using team members field 240. In some embodiments, the meeting coordinator may type in this information. In other embodiments, the meeting coordinator may drag-and-drop this information into the respect fields of the events. When entering this information, the meeting coordinator may preliminarily assign each event to a tentative time slot. As depicted in FIG. 2, events 205, 210, 215, and 220 have tentatively been scheduled to occur at 2:00, 2:30, 3:00, and 3:30 p.m., respectively.

The invitees may be located in different time zones, making it a difficult challenge for the meeting coordinator to contact the prospective attendees, find out times in which they will be available, determine which times do not conflict with other attendees schedules, arrange the events in a permissible manner where all schedules are compatible, and send out the meeting invitations. Many times in scheduling a meeting in this manner, there are conflicts among the prospective attendees. Consequently, the meeting coordinator may only be able to ensure that a primary person, or a delegated person, can attend. Occasionally, the meeting coordinator may also need to take additional time to confirm attendance, via an e-mail, a telephone call, or an instant message. For example, attendees may have to alter their schedules due to intervening conflicts. As one may readily conclude, this simple task of scheduling a meeting can easily get complicated and consume thirty minutes or more of work for the meeting coordinator.

The meeting coordinator may have an embodiment of the system, such as system 100, send invitations to each of the supervisors, team leaders, and team members. In other words, the supervisors, team leaders, and team members may be the prospective attendees for the meeting. Upon receiving the invitation, each of the prospective attendees may respond by indicating their preferences, such as which time they would like to attend or when they have conflicts. Additionally, depending on the embodiment, the prospective attendees may attach files related to the event, such as presentation documents, using link field 245. For example, team leaders of events 205 and 210 may attach documents via linked documents 250 and 255. Example filed may be electronic slides, spreadsheet files, and other types of demonstration files.

The system may receive such responses, or input, compute or evaluate the various combinations of events occurring at different times, and determine an arrangement of events that maximizes attendance by the largest number of prospective attendees. Alternatively, the meeting coordinator may indicate which prospective attendees must attend or which prospective attendees should attend if at all possible. In other words, the meeting coordinator may assign a weight or rating to one or more of the prospective attendees, based on whether the attendance is mandatory, highly desired, suggested, requested, or only offered. In this case, the system may evaluate the various combinations using these parameters.

Additionally, the meeting coordinator and the prospective attendees may enter other parameters for the events, such as which time slots are more important than others, which time slots are unavailable for certain attendees, which topics have priority over other topics, etc. The system may use these additional parameters when evaluating the various combinations of events to determine an acceptable arrangement of events. For example, based on the parameters defined by the prospective attendees and the meeting coordinator, the system may move event 210 from 2:30 p.m. to 3:30 p.m., and event 220 from 3:30 p.m. to 2:30 p.m. due to more team members of event 220 being able to attend at 2:30 p.m. versus 3:30 p.m.

In some embodiments, screen 200 may represent a schedule proposed by the system after the system goes out, queries the calendar entries of the prospective employees, and determines a recommended or proposed schedule. The meeting coordinator may accept the proposed arrangement of events and send out invitations to the prospective attendees to have them accept or place priorities on the individual time slots, based on their preferences of when they would like to attend. The system may continually receive such feedback, or input parameters, adjust the schedule accordingly, and update the calendars of the affected attendees based on the adjustments. In automating this process, the system may minimize the schedule impact of the people involved.

Depending on the embodiment, the system may submit proposed changes to the meeting coordinator for approval. In other words, the prospective attendees may request a new arrangement of the events but the meeting coordinator may either approve or disapprove of the changes. In even further embodiments, the system may allow the meeting coordinator to continually change the arrangement of events and modify event parameters.

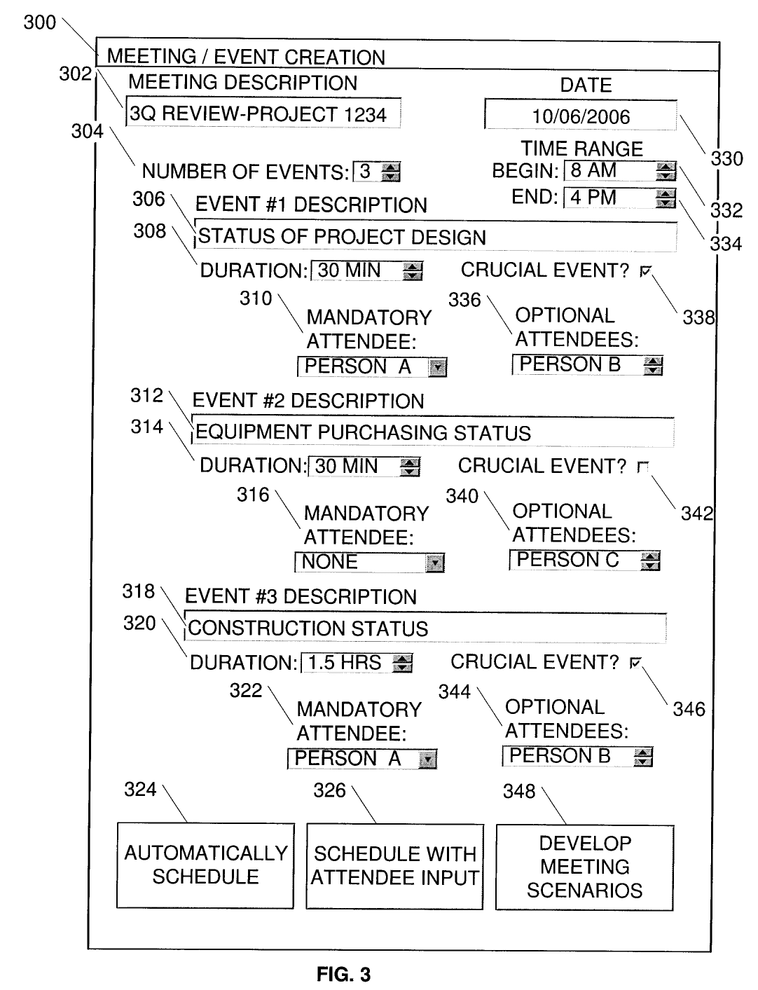

FIG. 3 illustrates an alternative embodiment of a graphical user interface (GUI) screen 300 that a meeting coordinator may use to create meetings, including the creation of events for the meetings. Screen 300 may be displayed on a variety of electronic devices. For example, screen 300 may be shown on a display screen, like display 110 of system 100 in FIG. 1, which may be a liquid crystal display screen of a PDA or laptop computer, or a CRT screen of a desktop computer.

Screen 300 may contain a number of text input fields allowing the meeting coordinator to define numerous parameters associated with the meeting being created. The meeting coordinator may enter a description for the meeting using text input field 302. The meeting coordinator may enter the date on which the meeting is to occur using text input field 330. Using scroll boxes 332 and 334, the meeting coordinator may define a time range for which the system should evaluate when attempting to define an arrangement of the events and scheduling the events on the electronic calendars of the attendees. The meeting coordinator may limit the range of time to only the amount of time needed to conduct the meeting. For example, the meeting may need to be held at a specific time for one reason or another. Alternatively, the meeting coordinator may specify an amount of time much larger than the amount of time needed to conduct the meeting. In so doing, the meeting coordinator may allow the system more flexibility in attempting to find a suitable arrangement of events compatible with the events already scheduled in the calendars of the prospective attendees.

Using scroll box 304, the meeting coordinator may define the number of events which are to occur during the meeting. The system may automatically increase or decrease the size of screen 300 to accommodate the selected number of events. As illustrated in FIG. 3, the meeting coordinator may enter descriptions 306, 312, and 318 to describe the first, second, and third events, respectively. Additionally, the meeting coordinator may define the duration of each event using scroll boxes 308, 314, and 320. For example, FIG. 3 shows that the meeting coordinator has defined the durations of events #1 and #2 to be 30 minutes each while the duration of event #3 is 1½ hours.

Using drop-down boxes 310, 316, and 322, the meeting coordinator may define mandatory attendance for each of the individual events. For example, FIG. 3 shows that “Person A” must attend event #1, while event #2 has no mandatory attendees listed. Using drop-down boxes 336, 340, and 344, the meeting coordinator may also define optional attendance for each of the individual events. Worth noting, even though FIG. 3 only shows one person in the drop-down boxes for the mandatory attendees and the optional attendees, more than one person may actually be selected. For example, drop-down box 344 may actually contain the names of fifteen people, not just “Person B.”

The meeting coordinator may also use checkboxes 338, 342, and 346 to define which events are crucial and which events are non-crucial. For example, FIG. 3 illustrates that the meeting coordinator has defined events #1 and #3 as crucial events, while event #2 is non-crucial. By distinguishing crucial and non-crucial events, the meeting coordinator may allow the system to schedule only the crucial events in the event that an acceptable time slot cannot be found for one or more of the non-crucial events. For example, if none of the optional attendees listed in scroll box 340 can attend the meeting, the system may propose an arrangement of events including only event #1 and event #3.

Once the meeting coordinator has defined the preliminary parameters of the meeting, the system may offer several scheduling alternatives. For example, the meeting coordinator may click on box 324 to have the system query the calendars of prospective attendees, propose an arrangement of events compatible with those calendars, and automatically schedule the meeting without first soliciting input from the prospective attendees. The attendees may, however, view the scheduled events in their calendars and attempt to modify or change the arrangement if the parameters for the various events allow. For example, “Person B” may view her calendar and see that the meeting has been scheduled for a particular time which she cannot attend. She may indicate her inability to attend at the scheduled time whereupon the system may automatically attempt to reschedule the meeting. In other words, the system may automatically try to determine another arrangement of the events compatible with the alternately defined parameters.

The meeting coordinator may click on box 326 to have the system first send out electronic invitations to the meeting before scheduling it in their calendars. For example, the system may send invitations via e-mail, electronic pages to pagers, or via instant messages or text messages sent to cellular telephones or PDAs of the prospective attendees. The prospective attendees may respond to the invitation by indicating their availability and their preferences for the various proposed time slots for the events. The system may receive such feedback in the form of parameters for the events and use those parameters to select arrangement and scheduled the select arrangement in the calendars of the attendees.

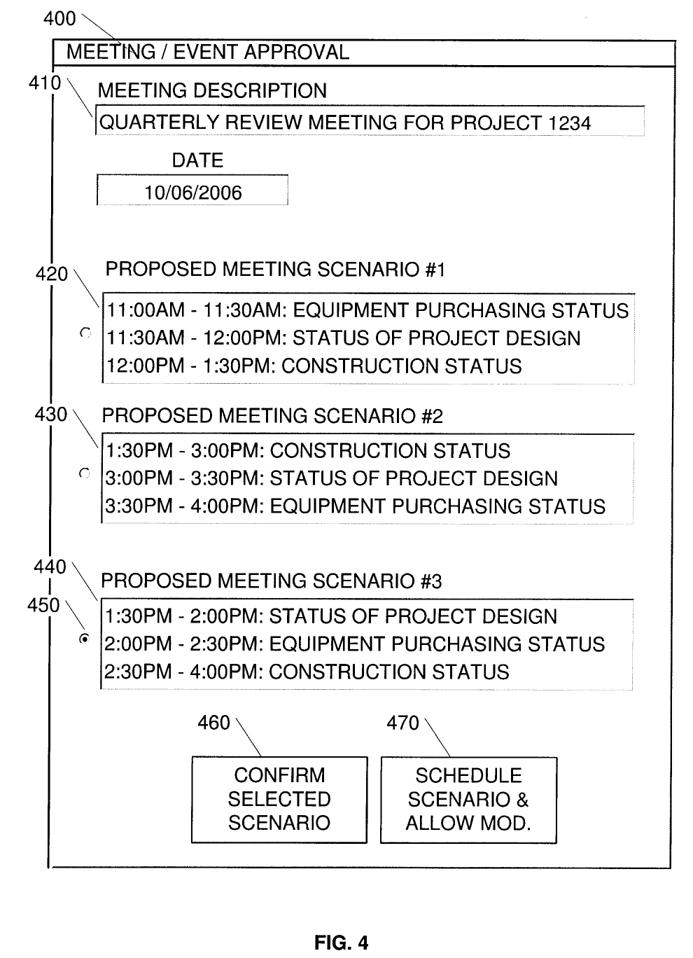

Alternatively, the meeting coordinator may click on box 348 to have the system query the calendars of prospective attendees, propose one or more arrangement of events compatible with those calendars, and display those arrangements to the meeting coordinator for selection or approval. To see example results of such a proposal, we turn now to FIG. 4.

FIG. 4 shows an embodiment of an interface screen 400 that a meeting coordinator may use to select among various proposed meeting scenarios. For example, an apparatus or system embodiment may generate screen 400 after the meeting coordinator has selected box 348 shown in FIG. 3. In other words, a system such as system 100 shown in FIG. 1 may generate screen 400 to make various schedule recommendations available to the meeting coordinator.

Screen 400 indicates a description 410 for which the various scenarios have been generated. Proposed meeting scenarios 420, 430, and 440, each indicate a different proposed arrangement of events, scheduled at different times within a specified time range. For example, meeting scenarios 420, 430, and 440 may have been generated by the system in response to the selections made by the meeting coordinator using the meeting creation screen 300 shown in FIG. 3. As shown in FIG. 3, the meeting coordinator selected a time range from 8 a.m. until 4 p.m. on Oct. 6, 2006. The first proposed meeting scenario 420 begins at 11 a.m. and ends at 1:30 p.m., with the equipment purchasing status event preceding the status of project design and construction status events. The second proposed meeting scenario 430 begins at 1:30 p.m. and ends at 4 p.m., with the construction status event preceding the status of project design and equipment purchasing status events. The third proposed meeting scenario 440 begins at 1:30 p.m. and ends at 4 p.m., with the arrangement of events being the status of project design, the equipment purchasing status, and the construction status.

As illustrated in FIG. 4, the meeting coordinator has selected the third proposed meeting scenario 440, indicated by the selected radio button 450. The meeting coordinator may confirm the third proposed meeting scenario 440 and have the system schedule the events in the electronic calendars of the prospective attendees by clicking on box 460. Depending on the embodiment, clicking on box 460 may not allow changes from prospective attendees. Alternatively, the meeting coordinator may instead click on box 470 to have the system schedule the third proposed meeting scenario 440 in the electronic calendars of the prospective attendees which are affected, yet allow the prospective attendees to provide their attendance preferences and potentially have the system generate and schedule an alternate arrangement of events. Also, depending on the embodiment, clicking box 460 and/or box 470 may cause the system to send invitations, such as invitations via e-mails or text messages.

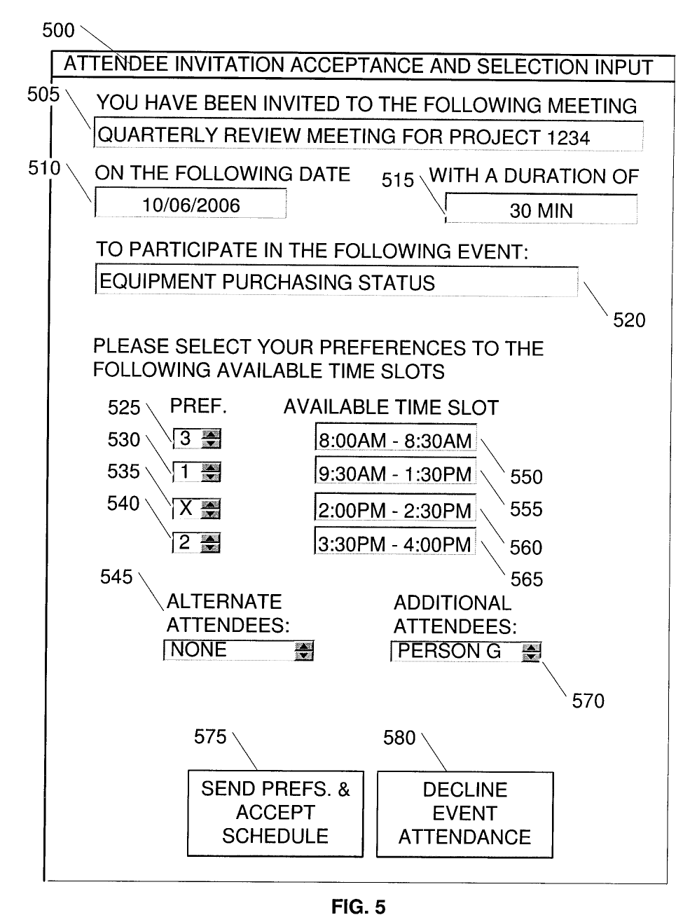

FIG. 5 shows an embodiment of an interface screen 500 that a prospective meeting attendee may use to respond to a meeting invitation and input preferences for various available time slots for one or more events of the meeting. As depicted in FIG. 5, screen 500 displays the description 505 and the date 510 of the meeting, the description 520 of the event for which the attendee is being invited to participate, and the event duration 515.

As described in the discussions for the previous figures, the system may have queried the electronic calendar of the prospective attendee and determined that four available time slots were available. For example, the system may have determined that the prospective attendee has time slots 550, 555, 560, and 565 available. The prospective attendee may indicate his preference for each of the available time slots using scroll boxes 525, 530, 535, and 540. As illustrated in FIG. 5, the prospective attendee has assigned a preference of one for time slot 555, a preference of two for time slot 565, and a preference of three for time slot 550. In other words, a prospective attendee may wish to first attend the meeting during the 9:30 a.m. to 1:30 p.m. time slot, attend the 3:30 p.m. to 4 p.m. time slot second, and 8 a.m. to 8:30 a.m. time slot 550 last. The prospective attendee may also indicate one or more time slots for which the attendee will be unavailable to attend the meeting. For example, a schedule conflict may arise after the details for the event have been entered and the invitations sent but before the meeting and associated events are actually prioritized, arranged, and scheduled. The prospective attendee may indicate such unavailability by entering a blank or an “X”, such as the “X” entered into scroll box 535 for time slot 560.

Worth emphasizing are the lengths of the proposed time slots. The proposed time slots may equal the event duration 515 or exceed the event duration 515. For example, time slots 550, 560, and 565 all have a duration matching the event duration 515. In other words, time slot 550, time slot 560, and time slot 565 are 30 minutes each. However, time slot 555 has a duration of four hours which considerably exceeds the 30 minute event duration 515. Proposing time slots with larger ranges may allow the system more flexibility in finding a 30 minute time slot compatible with the available time slots for other participants of the meeting.

Also as illustrated in FIG. 5, the prospective attendee may use scroll box 545 to indicate an alternate attendee to attend the meeting instead. Additionally, the prospective attendee may use scroll box 570 to specify one or more additional attendees which the prospective attendee would like to have attend the meeting. For example, the prospective attendee may see that the meeting coordinator omitted a crucial team member for the event and use scroll box 570 to ensure that the system sends an invitation to and schedules the omitted team member.

After assigning the various preference values for the proposed available time slots, the prospective attendee may click on the box 575 to send the preferences and accept the proposed schedule. For example, the preferences may be sent to and stored in database 120 shown in FIG. 1. Alternatively, the prospective attendee may decline event attendance altogether, for all of the proposed available time slots, by clicking box 580.

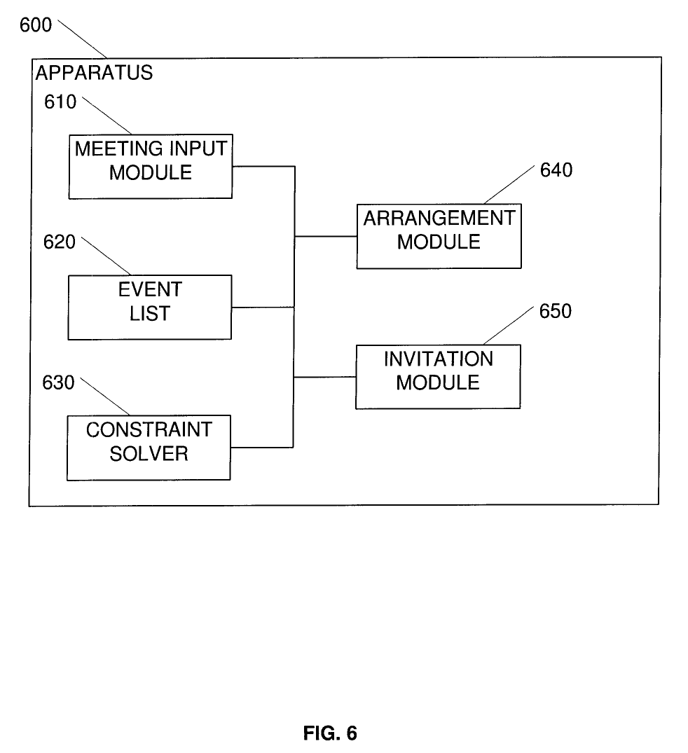

FIG. 6 shows an apparatus 600 for arranging events of a meeting. Apparatus 600, which may be in the form of hardware, software, or a combination of both, may comprise a meeting input module 610 to receive meeting details, such as a description for the meeting, the number of events for the meeting, the description for each of the events, one or more lists of prospective attendees for the individual events, and prioritization information for the events and/or prospective attendees. For example, meeting input module 610 may comprise a part of calendar application 130 and generate screen 200 shown in FIG. 2, or generate screen 300 shown in FIG. 3.

Apparatus 600 may have an event list 620 generated from the list of events entered for the meeting. Event list 620 may exist as information stored in a database, such as database 120 stored on a hard disk drive, or as information in random access memory, such as memory 125 shown in FIG. 1. Event list 620 may have numerous parameters associated with the events. For example, the parameters may be event durations, desired time slots entered by a meeting coordinator, potential time slots generated by one or more queries of the calendars of prospective attendees, priorities placed on the time slots and/or events by the prospective attendees and/or coordinator, desired schedule modifications due to schedule conflicts which arise, mandatory and optional attendees specified by the prospective attendees and/or coordinator, as well as whether individual events are crucial or non-crucial. These parameters are meant to be examples only. Actual embodiments may contain more or less parameters, or various combinations of parameters.

Apparatus 600 may have a constraint solver 630 to analyze the parameters of event list 620. For example, constraint solver 630 may evaluate the priorities selected by one or more of the prospective attendees for the events, weigh the preferences of the prospective attendees, compare the desired priorities with potential time slots, and determine which time slots, in varying combinations, may be available for the individual events.

Apparatus 600 may comprise an arrangement module 640 to select an arrangement of the events based on the analysis of constraint solver 630. For example, arrangement module 640 may work in conjunction with constraint solver 630 to generate various scenarios, or arrangement of events, to propose to the meeting coordinator and or prospective attendees. In other words, arrangement module 640 may generate a screen similar to screen 400 shown in FIG. 4. Additionally, arrangement module 640 may also select one or more alternative arrangements based on input solicited from prospective attendees, via invitation module 650, or modifications made by the meeting coordinator. For example, arrangement module 640 may generate an alternative arrangement of events due to a mandatory change of schedule by a mandatory attendee of the meeting.

Arrangement module 640 may also select an arrangement based on whether an attendee needs to participate in two events. For example, if one of the attendees has mandatory attendance for two events of the meeting, arrangement module 640 may attempt to schedule the events consecutively so that the attendee can attend the meeting once for both events, instead of appearing for one event, leaving in the middle of the meeting, and returning to the end of the meeting when the second event arises.

Arrangement module 640 may select a predefined arrangement of events entered by the meeting coordinator. For example, in one embodiment, the meeting coordinator may select an initial arrangement of events. If the parameters solicited or inputted from the various prospective attendees do not require that the order or other details be changed from the predefined arrangement, arrangement module 640 may select the predefined arrangement. In another embodiment, the meeting coordinator may select a certain order of events, or specify that certain attendees must attend, such that arrangement module 640 selects the predefined arrangement. For one example, the meeting coordinator may predefine an order of events but allow arrangement module to schedule what time of day, or even day of the week, that the meeting take place based on the schedules of the attendees.

Arrangement module 640, depending on the embodiment, may also schedule the events after selecting the arrangement. For example, after selecting an arrangement of events, arrangement module 640 may schedule the events for the affected attendees by placing an entry or making a reservation in their electronic calendar. Arrangement module 640 may make a single entry if an affected attendee is attending or participating in only one event, or it may make multiple entries or a larger single entry for a larger amount of time if the affected attendee is attending or participating in more than one event.

Apparatus 600 may have an invitation module 650 to send invitations, such as pager alerts or e-mail meeting invitations, to prospective attendees. The invitation module 650 may also solicit input for the parameters from the prospective attendees. For example, invitation module 650 may request one or more prospective attendees to prioritize the available time slots found to be available by constraint solver 630 and arrangement module 640.

Apparatus 600 may vary in different embodiments. Some embodiments may have fewer modules than those module depicted in FIG. 6. For example, one embodiment may not have a meeting input module 610. Input for the meetings may be generated, for example, by a meeting input module on another system not directly coupled to apparatus 600. Additionally, some embodiments may have different combinations of elements perform different functions. For example, in some embodiments a single module may perform the functions of both arrangement module 640 and constraint solver 630.

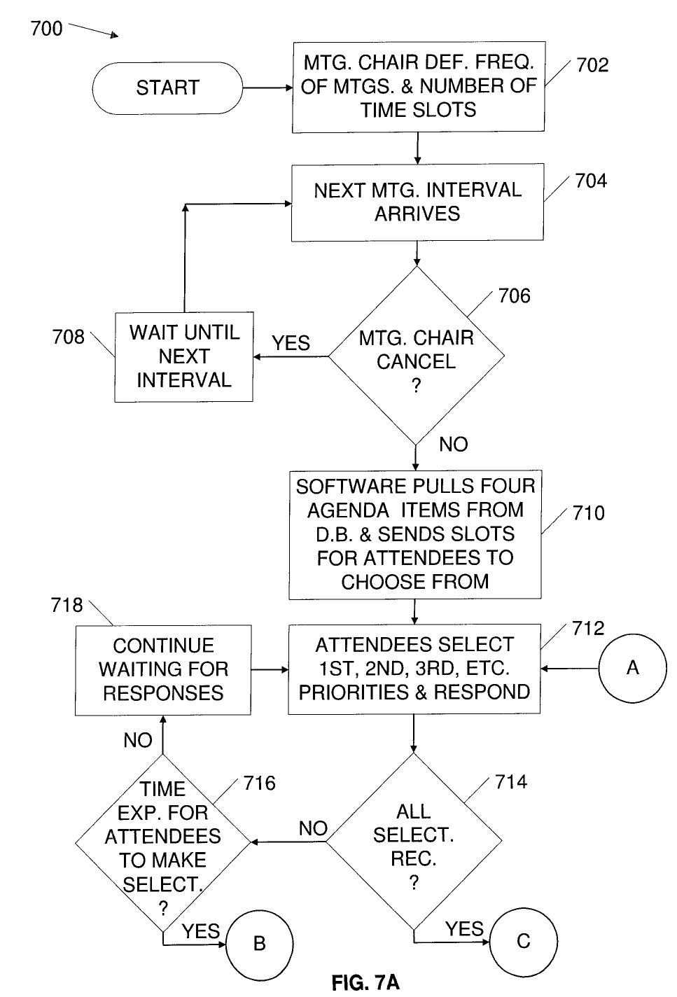

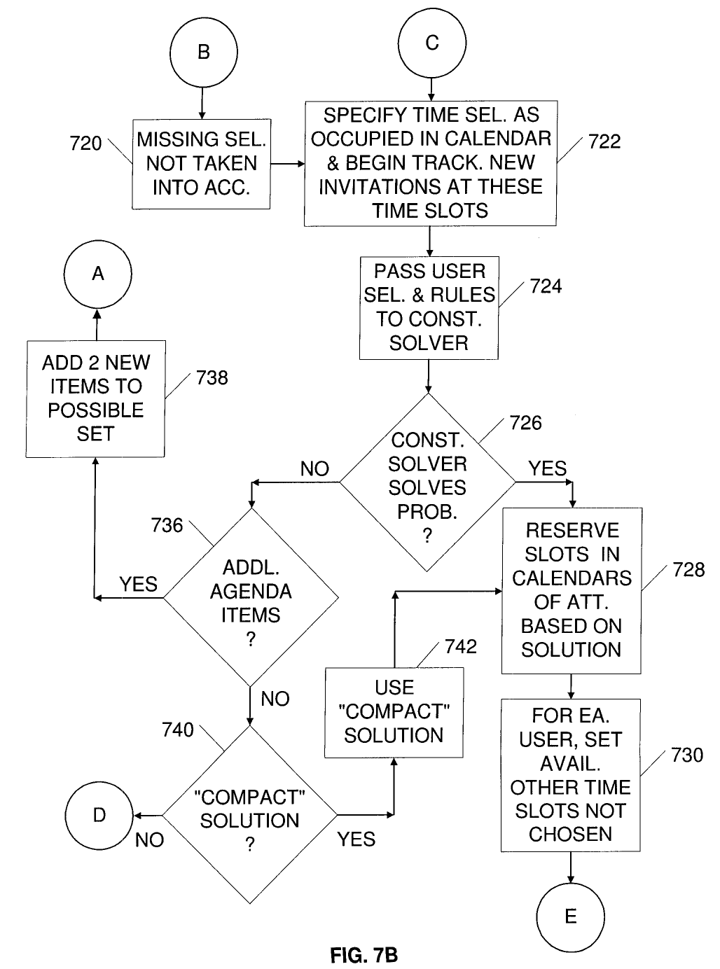

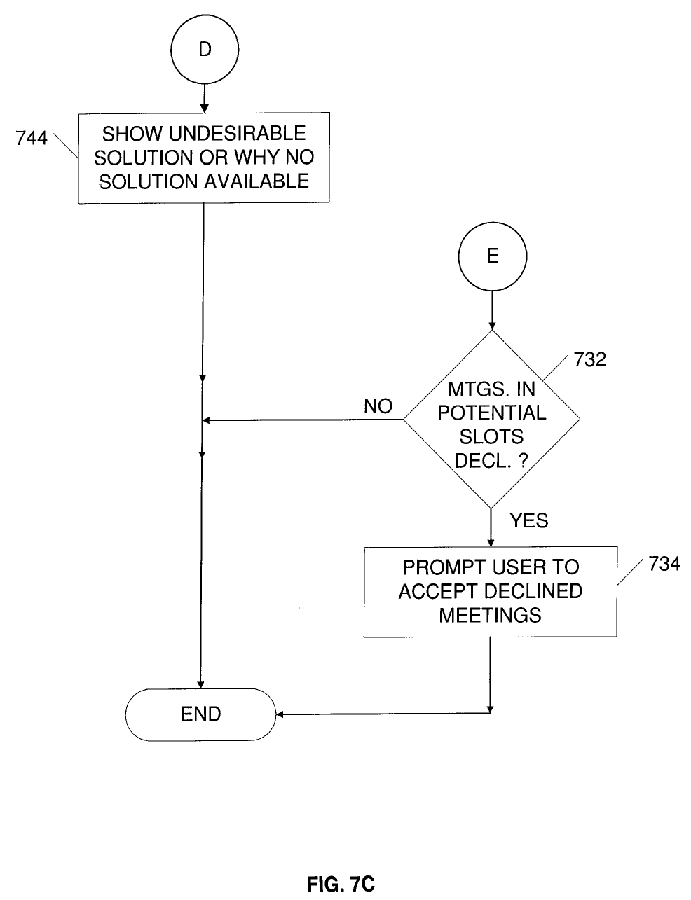

FIGS. 7A-7C depict a flowchart 700 of an algorithm for managing events in a calendar application based on parameters for the events. A meeting coordinator, or meeting chair, may define how often a recurring meeting is to be scheduled, as well as its duration (element 702). For example, the chair may desire that project meetings occur every Wednesday from 2:00 p.m. until 4:00 p.m. Whenever the next-available time interval for the meeting arrives (element 704), the algorithm may check to see if the meeting chair has cancelled meeting (element 706). This cancellation could be for a variety of reasons, such as the chair going on vacation, the next-scheduled interval lands on a holiday, etc.

If the meeting being considered has been cancelled, the algorithm may wait until the next interval to arrive (element 708) and go back to monitoring system time for the next meeting to arrive (element 704). If the meeting has not been cancelled, the algorithm may begin scheduling the meeting by first pulling a number of agenda items or events, such as four (4) if there are that many, from the database and sending lists of visual slots for attendees to choose their preferred times (element 710). Depending on the embodiment, time slots may be automatically grayed out if another calendar entry is already scheduled. Note also that the software may detect whether an attendee cannot attend any of the slots, and in such a case, not send an invitation to that particular attendee. This may not apply to primary or mandatory attendees, however.

In an enhanced user interface, such as a graphical user interface, prospective attendees may prioritize their preferred time slots, according to 1st, 2nd, 3rd, etc. preference and invoke a command to send selections back to the software algorithm (element 712). Note that the prospective attendees may only need to do this if they have not already responded with preferences, as element 712 may also be invoked from element 738, which will be discussed momentarily. The algorithm may then determine whether prioritized selections have been received from all prospective attendees (element 714). If all selections have not yet been received, the algorithm may determine whether a time limit for making selections has expired (element 716). Such a time limit may be a system-wide value, or defined individually, based on the preferences of the meeting chair.

If the time limit has not expired, the algorithm may continue to wait for additional selections (element 718) and return back to element 712. If the time limit has already expired, the selections for one or more of the missing attendees may not be taken into account by the scheduling algorithm (element 720). Based on the selections of the attendees that responded within the required time limit, the algorithm may automatically specify preferred time slots as occupied and begin tracking any new meeting invitations that may arrive for any of these time slots during the scheduling process (element 722). The algorithm may pass the selections of the attendees, as well as constraint rules, to a constraint solver (element 724).

One example of the constraint rules, or parameters, that the algorithm may evaluate for element 724 may be whether a primary attendee must be able to attend the time slot for the slot to be scheduled. Alternatively, the algorithm may evaluate whether agenda items that were submitted earlier in the queue should be given higher priority in the scheduling determination or whether the scheduling determination should accommodate user preferred selections as much as possible. The algorithm may initially try to accommodate the first choice for each attendee, try to accommodate the second choices, etc.

The algorithm may then make a determination as to whether an optimal or preferred solution may be found based on the input and constraining rules supplied to the constraint solver (element 726). If a solution can be found, the algorithm may automatically reserve the time slots on the calendars of the affected attendees (element 728) based on the solution the constraint solver developed. For the prospective attendees, the time slots that were not chosen may now be set as available or free in the calendars (element 730). As noted earlier in the discussion for element 722, all the preferred slots were set as occupied, or unavailable, in case the constraint solver picked any one of them.

The algorithm may then determine whether any meetings or sub-meetings were declined because of conflicts with potential slots that were set to “occupied” (element 732). In doing so, the algorithm may check to see if the affected attendees may now attend one of the declined meetings, due to the time slot being freed in element 730, because the constraint solver did not choose one of these time slots to use for those particular attendees. If there were declined meetings, the algorithm may prompt the attendees to see if they would like to attend them (element 734).

Referring back to element 726, in case the constraint solver was unable to come up with an optimal or preferred solution based on the inputs selected, the algorithm may then determine whether there are additional agenda items in the queue which may aid in scheduling or arranging the events (element 736). If there are, the algorithm may add more agenda items, such as two new agenda items if there are that many to the possible set (element 738). The algorithm may then rerun the scheduling process with the additional new agenda items (going back to element 712) to see if it can come up with a solution for element 726, with the additional input.

If there were no additional agenda items in the queue to use in helping to find a solution (element 736), the algorithm may make an additional determination as to whether a “compact” or different preferred solution is available (element 740). A compact solution may be one that has adjacent time slots with no intervening empty ones. For example, out of four agenda items, two consecutive time slots at 2:00 p.m. and 2:30 p.m. may be available. In the alternative, perhaps 3:00 p.m. and 3:30 p.m. may be available. An example of a non-compact solution may be a 2:00 p.m. time slot with only an associated 3:30 p.m. time slot available. Compact solutions, therefore, may be more desirable since they may allow the attendees more time to start later or additional time by finishing earlier.

If a compact solution is available, the algorithm may propose this solution (element 742) and proceed with reserving the time slots in the calendars of prospective attendees (element 728) as described earlier. If the algorithm can only find an undesirable solution, i.e. a non-compact is the only one possible, or if no solution is possible, then the algorithm may then ask the meeting chair if he/she would still like to schedule the non-compact solution or maybe a subset of the proposed solution (element 744). If no solution is available, the algorithm may indicate why. For example, the constraint solver may determine that no primary or mandatory attendees could attend the meeting or event that particular week. In this latter case, the meeting chair may choose wait until the next week before scheduling the meeting.

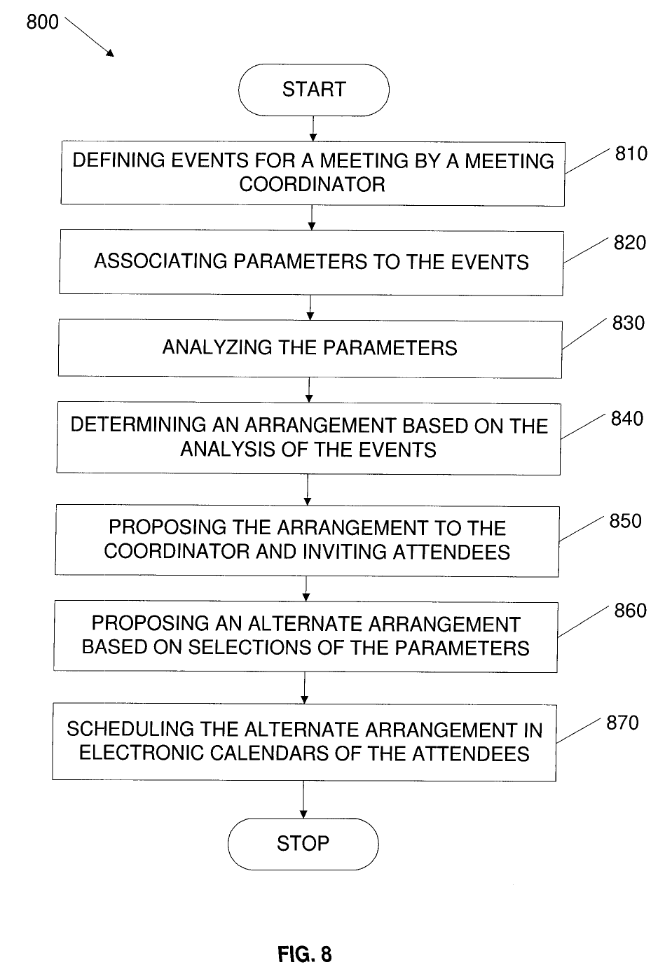

FIG. 8 illustrates a method embodiment 800 for arranging events of a meeting based on specified event parameters of prospective attendees for the meeting. An embodiment according to flowchart 800 begins with defining events for a meeting by a meeting coordinator (element 810). For example, a meeting coordinator may define meeting details, such as a description for the meeting, the number of events for the meeting, prospective attendees which need to attend for the individual events, and whether the individual events are crucial or non-crucial.

An embodiment of flowchart 800 continues by associating parameters to the events (element 820). For example, the embodiment may associate parameters to the events by finding free or available time in a schedule of a prospective attendee that falls within the time range specified by the meeting coordinator. A method embodiment according to the embodiment of FIG. 8 may proceed by analyzing the parameters (element 830). Based on the analysis (element 830), the embodiment may then determine an arrangement of events for the meeting (element 840). For example, the system of the embodiment may develop an arrangement of events that has all of the events occurring in consecutive time slots and matching each of the first preferences selected by each of the prospective attendees.

An embodiment of FIG. 8 may proceed by proposing the arrangement to the coordinator and inviting attendees (element 850). For example, a system according to the embodiment may generate a user screen similar to screen 200 depicted in FIG. 2 or screen 400 depicted in FIG. 4, and send e-mail notifications to the attendees asking them to accept or decline the meeting invitation. If any of the prospective attendees indicate that they cannot attend the meeting at the time slot proposed, or if the meeting coordinator decides to not accept the proposed arrangement, a system consistent with the embodiment of FIG. 8 may develop and propose an alternative arrangement (element 860).

Once the meeting coordinator and prospective attendees have accepted the proposed arrangement of events, or not made selections that make the alternative arrangement unacceptable, a system according to the embodiment may schedule the alternative arrangement in the electronic calendars of the prospective attendees (element 870).

Another embodiment of the invention is implemented as a program product for use with a system to manage events in time management or event scheduling applications, such as calendar applications in accordance with, e.g., calendar application 130 shown in FIG. 1. The program(s) of the program product defines functions of the embodiments (including the methods described herein) and can be contained on a variety of data and/or signal-bearing media. Illustrative data and/or signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the internet and other networks. Such data and/or signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by a computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates methods, systems, and program products for managing events in time management or event scheduling applications, such as calendar applications. It is understood that the form of the invention shown and described in the detailed description and the drawings are to be taken merely as examples. It is intended that the following claims be interpreted broadly to embrace all the variations of the example embodiments disclosed.

Although the present invention and some of its advantages have been described in detail for some embodiments, it should be understood that various changes, substitutions and alterations can be made herein without departing from the spirit and scope of the invention as defined by the appended claims. Further, embodiments may achieve multiple objectives but not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method to arrange events of a meeting, the method comprising:
defining the events of the meeting;
analyzing parameters of the events, wherein at least one of the parameters comprises a selection of a prospective attendee for at least one of the events; and
determining, by an apparatus, an arrangement of the events based on the analysis of the parameters.

2. The method of claim 1, further comprising sending invitations for the meeting to prospective attendees.

3. The method of claim 2, further comprising accepting, by at least one prospective attendee, an invitation for at least one of the events.

4. The method of claim 1, further comprising proposing the arrangement.

5. The method of claim 4, wherein the proposing the arrangement comprises scheduling the events in electronic calendars of the prospective attendees.

6. The method of claim 1, further comprising proposing an alternate arrangement of the events based on the analysis of the parameters.

7. The method of claim 6, wherein the alternate arrangement is based on a modification by one of a prospective attendee and a meeting coordinator.

8. The method of claim 1, wherein the determining an arrangement of the events based on the analysis of the parameters comprises analyzing selected time slots for the events received from a plurality of prospective attendees.

9. The method of claim 1, wherein the determining an arrangement of the events based on the analysis of the parameters comprises selecting an arrangement of the events predefined by a meeting coordinator.

10. A system for arranging events of a meeting, the system comprising:
a list of events for the meeting;
a constraint solver to analyze parameters of the events, wherein the parameters are from people associated with the events; and
an arrangement module to select an arrangement of the events based on analysis by the constraint solver.

11. The system of claim 10, further comprising a meeting input module to receive details of the events.

12. The system of claim 10, further comprising an invitation module to send invitations to prospective attendees.

13. The system of claim 12, wherein the invitation module solicits input of the parameters from the prospective attendees.

14. The system of claim 13, wherein the input of the parameters from the prospective attendees comprises one of an available time slot for an attendee, a priority of an available time slot for an attendee, acceptance of an invitation for at least one event, and a description of topics for an event.

15. The system of claim 13, wherein the invitation module communicates the selected arrangement to attendees for a specific event to solicit input for the specific event.

16. The system of claim 15, wherein the arrangement module selects an alternative arrangement based on the solicited input.

17. The system of claim 10, wherein the constraint solver analyzes an available time slot for at least one of the people, wherein the at least one of the people is a prospective attendee.

18. The system of claim 10, wherein the arrangement module selects the arrangement based on participation by an attendee in two consecutive events.

19. The system of claim 10, wherein the arrangement module automatically selects an alternative arrangement of the events based on a modification by a meeting chair or an attendee.

20. The system of claim 10, wherein the arrangement module selects a predefined arrangement of a meeting coordinator.

21. The system of claim 10, wherein the arrangement module schedules at least one of the events in a calendar of at least one prospective attendee.

22. A computer program product comprising a computer usable medium having computer usable program code for arranging events of a meeting, the computer program product including;
computer usable program code for analyzing event parameters, wherein the event parameters are from input of attendees to the meeting;
computer usable program code for determining an arrangement of the events based on the analysis of the event parameters; and
computer usable program code for scheduling the arrangement for the attendees.

23. The computer program product of claim 22, further comprising computer usable program code for to receive details of the events, send invitations to the attendees, and solicit input from the attendees.

24. The computer program product of claim 22, wherein the computer usable program code for determining the arrangement of the events based on the analysis of the event parameters comprises computer usable program code for determining the arrangement of the events based on the analysis of at least on one of an available time slot for an attendee, a priority of an available time slot for an attendee, and multiple available time slots for the events received from multiple attendees.

25. The computer program product of claim 22, wherein the computer usable program code for scheduling the arrangement for the attendees comprises computer usable program code for sending the arrangement to a meeting coordinator for approval.
